(19) United States
(12) Patent Application Publication
(10) Pub. No.: US 2026/0292933 A1
(43) Pub. Date: Sep. 24, 2026

(54) METHOD AND DEVICE FOR EFFICIENT HANDLING OF EMERGENCY SERVICES IN 5G PROXIMITY SERVICES UE-TO-NETWORK RELAY

(71) Applicant: Beijing Xiaomi Mobile Software Co., Ltd., Beijing (CN)

(72) Inventor: Jianning LIU, Beijing (CN)

(73) Assignee: Beijing Xiaomi Mobile Software Co., Ltd., Beijing (CN)

(21) Appl. No.: 19/472,563

(22) PCT Filed: Apr. 7, 2023
(86) PCT No.: PCT/CN2023/087154

§ 371 Date: Oct. 3, 2025

(51) Int. Cl. H04W 76/50; H04W 64/00; H04W 88/04

(52) U.S. Cl. CPC H04W 76/50; H04W 64/00; H04W 88/04

(57) ABSTRACT

An emergency-services handling technique for a UE-to-Network (U2N) relay in a 5G system is disclosed. The U2N relay establishes a Packet Data Unit (PDU) session for an emergency service and adapts relay discovery behavior accordingly. In one embodiment, while an emergency PDU session is ongoing, discovery parameters broadcast by the relay are updated to advertise only non-emergency Relay Service Codes (RSCs); in another embodiment, the relay limits advertised dedicated emergency RSCs to those supporting ProSe Layer-2 U2N relay service while excluding Layer-3. The broadcast discovery parameters can include a User-Info ID, RSCs, a per-RSC U2N Relay Layer Indicator identifying ProSe Layer-2 or Layer-3 service, and an optional per-RSC control-plane security indicator. The relay may participate in emergency relay discovery only when an AMF indicates Emergency Service Support in a latest Registration Accept for a ProSe remote UE, and may perform authorization/provisioning for ProSe Layer-3 relay and remote UE.

### CROSS-REFERENCE TO RELATED APPLICATION

The present application is a U.S. National Stage of International Application No. PCT/CN2023/087154, filed on Apr. 7, 2023, the contents of which are incorporated herein by reference in their entirety.

### TECHNICAL FIELD

The present disclosure relates to the field of telecommunication, and more specifically to a method for efficient handling of emergency services in a fifth-generation (5G) Proximity Services (ProSe) UE-to-Network Relay system.

### BACKGROUND

In the 5G ProSe UE-to-Network relaying, if there is an emergency request from the remote User Equipment (UE), it implies that the Relay UE needs to be responsible for the remote UE's emergency service. It is required that the Relay UE has a valid Subscriber Identity Module (SIM)/Universal Subscriber Identity Module (USIM)/International Mobile Subscriber Identity (ISIM). Existing technologies have proposed options for handling emergency services in 5G ProSe UE-to-Network Relay systems, but these options have not been adopted due to their inefficiency and limitations.

For instance, when the UE-to-Network Relay has one PDU session for an emergency service, it will reject all requests for emergency service via 5G ProSe Layer-3 UE-to-Network Relay from remote UE(s). However, the U2N Relay may still broadcast Relay Discovery parameters that include information to support emergency service via 5G ProSe Layer-3 UE-to-Network Relay from remote UE(s), which is not possible when the U2N Relay has an ongoing PDU session for the emergency service. This inefficient broadcasting leads to a waste of resources and delays in emergency service provision.

### SUMMARY

It is an object of the present disclosure to provide a method for efficient handling of emergency services in 5G Proximity Services UE-to-Network Relay. The corresponding device, computer-readable medium and computer program are also provided.

The problem is solved by a method according to claim 1, a UE-to-Network Relay according to claim 7, a computer program according to claim 8 and a computer-readable medium according to claim 9.

In particular, the present disclosure provides a method for efficient handling of emergency services in a 5G Proximity Services (ProSe) UE-to-Network Relay system, thereby avoiding resource waste and unnecessary delays in providing emergency services to remote UEs.

In a first aspect a method is provided for handling emergency services in a 5G ProSe UE-to-Network Relay system. The method includes establishing a Packet Data Unit (PDU) session for a UE-to-Network (U2N) Relay for an emergency service, and updating discovery parameters broadcast by the U2N Relay to include only non-emergency Relay Service Codes (RSCs) when the U2N Relay has an ongoing PDU session for the emergency service. Therein, the emergency service may be either an emergency service initiated by a remote UE or the emergency service for the U2N relay its own. Further, non-emergency RSCs are used specifically for non-emergency situations, such as making a phone call to a business, ordering food at a restaurant, or scheduling an appointment. The non-emergency RSCs are used to indicate to the relay operator the type of communication needed, such as a voice-to-text conversation, a text-to-voice conversation, or a video relay conversation. Thus, preferably, according to the present disclosure, the updated discovery parameters remove the emergency RSCs from the conventional discovery parameter. This method achieves the beneficial technical effect of preventing remote UEs from attempting to initiate emergency services through the U2N Relay when it is not available for relaying such services.

Preferably, the method further includes broadcasting discovery parameters such as a User Info identifier (ID), Relay Service Codes (RSCs), a UE-to-Network Relay Layer Indicator per RSC, and an optional Control Plane Security Indicator per RSC. This enables remote UEs to acquire necessary information about available relay services and their characteristics.

Preferably, the UE-to-Network Relay Layer Indicator indicates whether the associated RSC is offering 5G ProSe Layer-2 or Layer-3 UE-to-Network Relay service. This allows remote UEs to identify the type of relay service provided by the U2N Relay.

Preferably, the U2N Relay updates the discovery parameters to only include dedicated emergency RSC that supports the 5G ProSe Layer-2 UE-to-Network Relay Service, excluding the dedicated emergency RSC that supports the 5G ProSe Layer-3 UE-to-Network Relay Service. This prevents remote UEs from attempting to connect to an unavailable Layer-3 emergency service.

Preferably, the U2N Relay participates in the relay discovery procedure for emergency service only when the Access and Mobility Management Function (AMF) has included in the latest Registration Accept the Emergency Service Support indicator for emergency service from the 5G ProSe Remote UE. This ensures that the U2N Relay only offers emergency relay services when authorized by the AMF.

Preferably, service authorization and provisioning are performed for the 5G ProSe Layer-3 UE-to-Network Relay and 5G ProSe Layer-3 Remote UE. This ensures proper service configuration and authorization for the involved UEs. The Access and Mobility Management Function (AMF) is a central control entity in the 5G network architecture responsible for managing various aspects of UE connectivity, including access, mobility, and security. It plays a crucial role in ensuring that the network operates efficiently and securely. Thereby ensuring that the U2N Relay only offers emergency relay services when authorized by the AMF, providing a controlled and secure environment for handling emergency services in a 5G ProSe UE-to-Network Relay system. This approach contributes to efficient resource allocation and prevents unauthorized access to emergency services, enhancing overall network performance and reliability.

Preferably, the U2N Relay ceases to advertise its support of emergency service and rejects any 5G ProSe Remote UE's requests for relaying emergency services when the U2N Relay initiates the emergency service. Therefore, it is ensured that the U2N Relay can focus on its on going emergency service without being burdened by remote UE's emergency service requests.

Preferably, the U2N Relay prioritizes its own emergency service establishment and stops relaying the remote UE's emergency service if the U2N Relay is currently relaying an emergency service for a remote UE. This allows the U2N Relay to handle its own emergency service with higher priority, ensuring a timely response.

Preferably, the U2N Relay establishes a PDU session for a remote UE's emergency service based on an existing procedure. This embodiment provides a standardized approach to handling remote UE's emergency services.

In another aspect of the present disclosure, a U2N relay is provided. The U2N relay may comprise a memory and a processor, wherein instructions are stored in the memory, which when executed by the processor perform the steps of the method for handling of emergency services as described before.

In another aspect of the present disclosure, a computer-readable storage medium is provided comprising instructions to perform the steps of the method for handling of emergency services as described before.

In another aspect of the present disclosure, a computer program is provided comprising instructions which, when the program is executed by a UE-to-Network, U2N, Relay, cause the U2N Relay to carry out the method for handling of emergency services as described before.

### BRIEF DESCRIPTION OF DRAWINGS

In the following, the present disclosure is described in more detail with reference to the accompanying figures.

FIG. 1 is a flow diagram of the method for efficient handling of emergency services in 5G Proximity Services UE-to-Network Relay,

FIG. 2 illustrates an embodiment according to the present disclosure,

FIG. 3 illustrates a UE-to-Network relay.

### DETAILED DESCRIPTION

The present disclosure proposes an improved mechanism for handling emergency services in a 5G Proximity Services (ProSe) UE-to-Network Relay system. The method helps to efficiently manage emergency services in the system, ensuring timely assistance to remote UEs while avoiding resource waste and unnecessary delays.

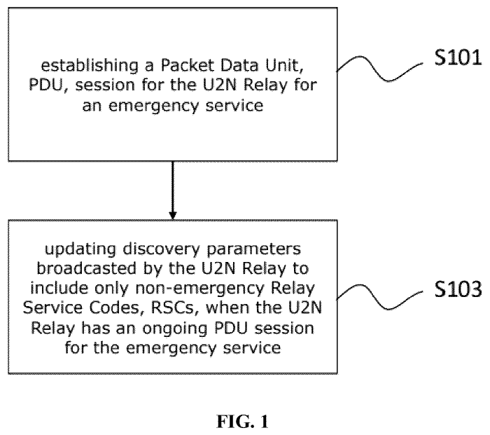

Referring to FIG. 1, which shows a flow diagram of the proposed method. The method includes the steps:
S101: establishing a Packet Data Unit (PDU) session for a UE-to-Network (U2N) Relay for an emergency service.
S103: when the U2N Relay has an ongoing PDU session for the emergency service, the discovery parameters broadcasted by the U2N Relay are updated to include only non-emergency Relay Service Codes (RSCs).

This prevents remote UEs from attempting to initiate emergency services through the U2N Relay when it is not available for relaying such services.

The U2N Relay may broadcast discovery parameters, including a User Info ID, Relay Service Codes (RSCs), a UE-to-Network Relay Layer Indicator per RSC, and an optional Control Plane Security Indicator per RSC.

User Info ID: a unique identifier assigned to a user or a device in the network. The User Info ID may be used to identify the user/device in the network and enable communication.

Relay Service Codes (RSCs): RSCs are codes used by a relay service to indicate the type of communication needed between two parties. These codes may be used to indicate the type of relay service needed, such as voice-to-text, text-to-voice, or video relay.

UE-to-Network Relay Layer Indicator per RSC: This parameter may indicate the relay layer at which communication is being established. The relay layer can be either Layer 2 or Layer 3, and this parameter helps to ensure that the relay service is established at the correct layer.

Control Plane Security Indicator per RSC: This parameter may indicate whether the control plane of the relay service is secure or not. The control plane may refer to the portion of the relay service that is responsible for managing the communication between the devices.

Thus, remote UEs can acquire necessary information about available relay services and their characteristics through these broadcast discovery parameters.

The UE-to-Network Relay Layer Indicator may indicate whether the associated RSC is offering 5G ProSe Layer-2 or Layer-3 UE-to-Network Relay service. This allows remote UEs to identify the type of relay service provided by the U2N Relay.

In some embodiments, when the U2N Relay initiates the emergency service, it ceases to advertise its support of emergency service and rejects any 5G ProSe Remote UE's requests for relaying emergency services. This ensures that the U2N Relay can focus on its ongoing emergency service without being burdened by remote UE's emergency service requests.

In some embodiments, if the U2N Relay is currently relaying an emergency service for a remote UE, it prioritizes its own emergency service establishment and stops relaying the remote UE's emergency service. This allows the U2N Relay to handle its own emergency service with higher priority, ensuring a timely response.

In some embodiments, the U2N Relay updates the discovery parameters to only include the dedicated emergency RSC that supports the 5G ProSe Layer-2 UE-to-Network Relay Service, excluding the dedicated emergency RSC that supports the 5G ProSe Layer-3 UE-to-Network Relay Service. This prevents remote UEs from attempting to connect to an unavailable Layer-3 emergency service.

In some embodiments, when establishing a Radio Resource Control (RRC) connection if a PC5 connection is requested using an emergency RSC, the U2N Relay sets the RRC Establishment cause to “emergency.” This ensures that the network is aware of the emergency nature of the RRC connection request.

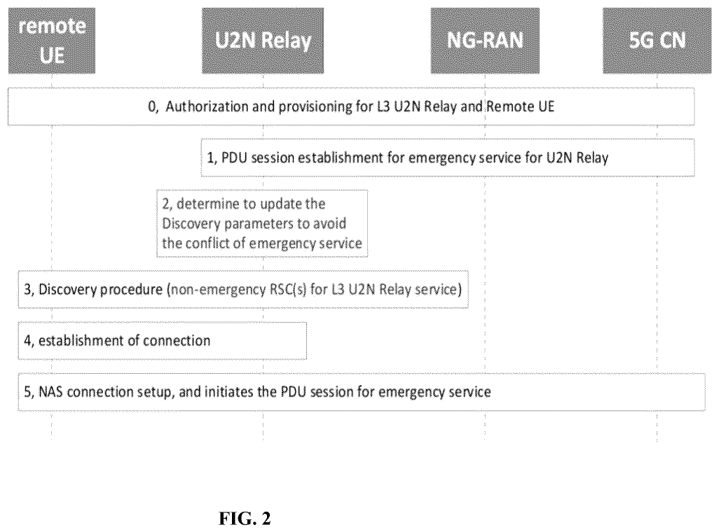

Reference is now made to FIG. 2, which shows an embodiment according to the present disclosure.
0. Service authorization and provisioning are performed for the 5G ProSe Layer-3 UE-to-Network Relay and 5G ProSe Layer-3 Remote UE. During this procedure, the relay services code offering the emergency service is provisioned to the remote UE and the relay UE. The detailed procedure is described, for example, in 3GPP TS 23.304V 18.1.0 , clause 6.2. The relevant part is herewith incorporated into the present disclosure. This ensures proper service configuration and authorization for the involved UEs.
1. The 5G ProSe Layer-3 UE-to-Network Relay establishes a PDU Session for its own emergency service based on the existing procedure. The detailed procedure is also described for example, in 3GPP TS 23.304V 18.1.0 , clause 6.5.1.1. The relevant part is herewith incorporated to the present disclosure. This provides a standardized approach to handling remote UE's emergency services.
2. When U2N Relay initiates its own emergency service, it determines to update the Discovery parameters to only include the dedicated emergency RSC, which only supports the 5G ProSe Layer-2 UE-to-Network Relay Service. (The dedicated emergency RSC that supports the 5G ProSe Layer-3 UE-to-Network Relay Service is not included). Therefore, the updated discovery parameters may prevent remote UEs from attempting to connect to an unavailable Layer-3 emergency service.
3. Remote UE obtains the discovery message about the emergency service information during the Discovery procedure from the U2N Relay. Thus, the remote UE is informed about the updated discovery parameters.
4. Remote UE establishes the PC5 connection between Remote UE and U2N Relay for Relay service.
5. Remote UE sends the NAS message via the established 5G ProSe Layer-2 UE-to-Network Relay Service, and establishes the PDU session for the remote UE's emergency service.

Therefore, according to the above-described embodiments, conflicts between emergency services can be properly handled.

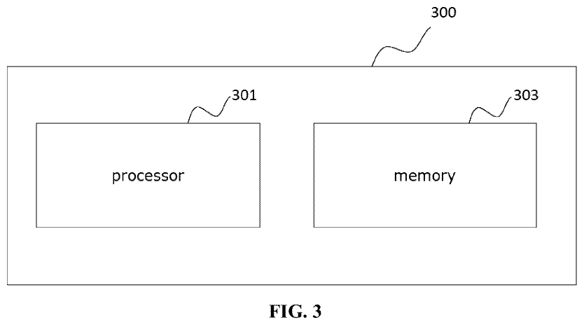

Reference is now made to FIG. 3, which shows a simplified block diagram of an example embodiment of a UE-to-Network Relay 300. Preferably, the U2N relay is a UE. The U2N relay 300 includes a processor 301 and a memory storage device 303. The memory storage device 303 may store a computer program or application containing instructions that, when executed, cause the processor 301 to perform operations such as those described herein. For example, the instructions may handle emergency service in accordance with the methods described herein. It will be understood that the instructions may be stored on a non-transitory computer-readable medium, such as a compact disc, flash memory device, random access memory, hard drive, etc. When the instructions are executed, the processor 301 carries out the operations and functions specified in the instructions so as to operate as a special-purpose processor that implements the described process(es). Such a processor may be referred to as a “processor circuit” or “processor circuitry” in some examples.

The disclosed methods and embodiments provide efficient handling of emergency services in a 5G Proximity Services (ProSe) UE-to-Network Relay system, ensuring timely assistance to remote UEs while avoiding resource waste and unnecessary delays.

Certain adaptations and modifications of the described embodiments can be made. Therefore, the above discussed embodiments are considered to be illustrative and not restrictive. In particular, embodiments can be freely combined with each other.

1. A method for handling emergency services, performed by a UE-to-Network (U2N) Relay in a fifth-generation (5G) wireless, 5G, system, the method comprising:
establishing a Packet Data Unit (PDU) session for the U2N Relay for an emergency service; and
updating discovery parameters broadcasted by the U2N Relay to comprise only non-emergency Relay Service Codes (RSCs) when the U2N Relay has an ongoing PDU session for the emergency service.

2. The method of claim 1, further comprising broadcasting discovery parameters comprising one or more of: a User Info identifier (ID), RSCs, a U2N Relay Layer Indicator per RSC, and an optional Control Plane Security Indicator per RSC.

3. The method of claim 2, wherein the U2N Relay Layer Indicator indicates whether an associated RSC is offering 5G Proximity Services, (ProSe) Layer-2 or Layer-3 U2N Relay service.

4. The method of claim 1, wherein the U2N Relay updates the discovery parameters to only comprise dedicated emergency RSC that supports the 5G Proximity Services (ProSe) Layer-2 U2N Relay Service, excluding dedicated emergency RSC that supports the 5G ProSe Layer-3 U2N Relay Service.

5. The method of claim 1, wherein the U2N Relay participates in the relay discovery procedure for emergency service only when an Access and Mobility Management Function (AMF) is included in the latest Registration Accept the Emergency Service Support indicator for emergency service from a 5G ProSe Remote UE.

6. The method of claim 1, further comprising performing service authorization and provisioning for the 5G Proximity Services (ProSe) Layer-3 U2N Relay and 5G ProSe Layer-3 Remote UE.

7. A UE-to-Network (U2N) Relay comprising:
a memory that stores instructions; and
one or more processors communicatively coupled to the memory,
wherein the instructions when collectively executed by the one or more processors, cause the U2N relay to:
establish a Packet Data Unit (PDU) session for the U2N Relay for an emergency service; and
update discovery parameters broadcasted by the U2N Relay to comprise only non-emergency Relay Service Codes (RSCs) when the U2N Relay has an ongoing PDU session for the emergency service.

8. (canceled)

9. A non-transitory computer-readable medium comprising instructions which, when executed by a processor or the UE-to-Network (U2N) Relay, cause the U2N Relay to carry out the method of claim 1.

10. A method for handling emergency services, performed by a UE-to-Network (U2N) Relay and a User Equipment (UE) in a fifth-generation (5G) wireless system, the method comprising:
establishing, by the U2N relay, a Packet Data Unit (PDU) session for the U2N Relay for an emergency service;
updating discovery parameters broadcasted by the U2N Relay to comprise only non-emergency Relay Service Codes, (RSCs) when the U2N Relay has an ongoing PDU session for the emergency service;
obtaining, by the UE, discovery parameters broadcasted by the U2N Relay;
establishing, by the UE, a PC5 connection with the U2N Relay for Relay service; and
establishing, by the UE, a second PDU session for a second emergency service.

11. A system comprising:
a UE-to-Network (U2N) Relay, configured to perform the method according to claim 1;
and a User Equipment (UE), wherein the UE configured to:
establish a Packet Data Unit (PDU) session for the U2N Relay for the emergency service;
update discovery parameters broadcasted by the U2N Relay to comprise only non-emergency Relay Service Codes, (RSCs) when the U2N Relay has an ongoing PDU session for the emergency service;
obtain discovery parameters broadcasted by the U2N Relay;
establish a PC5 connection with the U2N Relay for Relay service; and
establish a second PDU session for a second emergency service.

12. The U2N Relay of claim 7, wherein the instructions when collectively executed by the one more processors further cause the U2N relay to:
broadcast discovery parameters comprising one or more of: a User Info identifier (ID), RSCs, a U2N Relay Layer Indicator per RSC, and an optional Control Plane Security Indicator per RSC.

13. The U2N Relay of claim 12, wherein the U2N Relay Layer Indicator indicates whether an associated RSC is offering 5G Proximity Services (ProSe) Layer-2 or Layer-3 U2N Relay service.

14. The U2N Relay of claim 7, wherein the instructions when collectively executed by the one more processors further cause the U2N relay to:
update the discovery parameters to only comprise dedicated emergency RSC that supports the 5G Proximity Services (ProSe) Layer-2 U2N Relay Service, excluding dedicated emergency RSC that supports the 5G ProSe Layer-3 U2N Relay Service.

15. The U2N Relay of claim 7, wherein the U2N Relay participates in the relay discovery procedure for emergency service only when an Access and Mobility Management Function (AMF) has comprised in the latest Registration Accept the Emergency Service Support indicator for emergency service from a 5G ProSe Remote UE.

16. The U2N Relay of claim 7, wherein the instructions when collectively executed by the one more processors further cause the U2N relay to:
perform service authorization and provisioning for the 5G Proximity Services (ProSe) Layer-3 U2N Relay and 5G ProSe Layer-3 Remote UE.
